(19) United States
(12) Patent Application Publication
(10) Pub. No.: US 2016/0292067 A1
(43) Pub. Date: Oct. 6, 2016

(54) SYSTEM AND METHOD FOR KEYWORD BASED TESTING OF CUSTOM COMPONENTS

(71) Applicant: HCL Technologies Ltd., Noida (IN)

(72) Inventors: Daljeet Singh, Noida (IN); Sourav Dey, Bangalore (IN)

(21) Appl. No.: 15/065,038

(22) Filed: Mar. 9, 2016

(30) Foreign Application Priority Data
Apr. 6, 2015 (IN) 970/DEL/2015

(51) Int. Cl. G06F 11/36; G06F 17/30

(52) U.S. Cl. CPC G06F 11/3668; G06F 17/30917; G06F 17/30312

(57) ABSTRACT

Systems and methods for testing a custom component associated with a software application. A set of custom components and a set of metadata associated with the set of components are received from a third party developer in an XML file. The metadata includes a plurality of attributes categorized into a plurality of categories. The set of custom components and the set of metadata are stored in an object repository. A custom component from the software application is selected for testing over a test grid. Metadata associated with the custom component is identified from the object repository. An attribute of each category from the metadata corresponding to the custom component is selected in order to generate an event set corresponding to the custom component wherein the event set comprises the attribute selected for testing the custom component.

### CROSS-REFERENCE TO RELATED APPLICATIONS AND PRIORITY

The present application claims benefit from Indian Complete Patent Application No. 970/DEL/2015, filed on Apr. 6, 2015, the entirety of which is hereby incorporated by reference.

### TECHNICAL FIELD

The present disclosure in general relates to the field of software testing. More particularly, the present invention relates to a system and method for testing custom components present in a software application.

### BACKGROUND

Presently, Information Technology (IT) Organizations are adopting new strategies for developing software applications in less time. The development of complex and larger software applications and changes in software project execution models like Spiral and Agile development models has resulted in short release cycles. Many IT organizations are now adopting new strategies in order to develop software in less time. However, due to quality requirements, the software application need to undergo software testing every time before the new version of the software application is released. Further, with the introduction of new programming languages like HTML5, custom components can be developed by the developers in order to meet client requirements. However, at present, there are no automated testing tools available that can recognize and test custom components that are added in the software application.

Furthermore, for better maintainability and efficiency of test cases, automation engineers use frameworks like keyword based frameworks or data driven frameworks. Such frameworks depend on manually creating test cases using keywords and finders. Test engineers often use an object repository for testing components associated with the software application. However, creating the object repository is a manual and tedious process and the majority of testing frameworks and software testing tools available in the art do not support maintaining or testing custom components in the object repository.

### SUMMARY

This summary is provided to introduce aspects related to systems and methods for testing a custom component associated with a software application and the aspects are further described below in the detailed description. This summary is not intended to identify essential features of the claimed subject matter nor is it intended for use in determining or limiting the scope of the claimed subject matter.

In one embodiment, a system for testing a custom component associated with a software application is illustrated. The system comprises a memory and a processor coupled to the memory, wherein the processor is configured to receive a set of custom components and a set of metadata associated with the set of components, wherein each metadata comprises a plurality of attributes categorized into a plurality of categories. These categories comprise a component type, a component finder, an action, and a value associated with the custom component. Further, the processor is configured to store the set of custom components and the set of metadata in an object repository. Furthermore, the processor enables a user to select a custom component from the software application for testing over a test grid. Once the custom component is selected, the processor enables identifying the metadata associated with the custom component, from the object repository. Finally, the processor enables a user to select an attribute of each category from the metadata corresponding to the custom component in order to generate an event set corresponding to the custom component, wherein the event set comprises the attribute selected for testing the custom component.

In one embodiment, a method for testing a custom component associated with a software application is disclosed. Initially, a set of custom components and a set of metadata associated with the set of components are received by a processor, wherein each metadata comprises a plurality of attributes categorized into a plurality of categories. These categories comprise a component type, a component finder, an action, and a value associated with the custom component. In the next step, the set of custom components and the set of metadata are stored in an object repository by the processor. Further, a custom component is selected from the software application for testing over a test grid. In the next step, the metadata associated with the custom component is identified by the processor, from the object repository. Finally, the processor enables a user to select an attribute of each category from the metadata corresponding to the custom component in order to generate an event set corresponding to the custom component, wherein the event set comprises the attribute selected for testing the custom component.

In one embodiment, a computer program product having embodied computer program for testing a custom component associated with a software application is disclosed. The program comprises a program code for receiving a set of custom components and a set of metadata associated with the set of components, wherein each metadata comprises a plurality of attributes categorized into a plurality of categories. The program further comprises a program code for storing the set of custom components and the set of metadata in an object repository. The program further comprises a program code for selecting a custom component, from the software application, for testing over a test grid. The program further comprises a program code for identifying metadata associated with the custom component from the object repository. The program further comprises a program code for selecting an attribute of each category from the metadata corresponding to the custom component in order to generate an event set corresponding to the custom component, wherein the event set comprises the attribute selected for testing the custom component.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for testing a custom component associated with a software application, in accordance with an embodiment of the present subject matter.

FIG. 2 illustrates the system for testing the custom component associated with the software application, in accordance with an embodiment of the present subject matter.

FIG. 3 illustrates a block diagram for testing the custom component, in accordance with an embodiment of the present subject matter.

FIGS. 4a-4d illustrates a test grid for testing the custom component, in accordance with an embodiment of the present subject matter.

### DETAILED DESCRIPTION

The present subject matter relates to a system for testing a custom component associated with a software application. The system comprises a memory and a processor coupled to the memory, wherein the processor is configured to receive a set of custom components and a set of metadata associated with the set of components. The metadata comprises a plurality of attributes categorized into a plurality of categories. These categories comprise a component type, a component finder, an action, and a value associated with the set of custom components. In one embodiment, the set of custom components may be a User Interface (UI) custom component. The UI custom component is a unit of the software application with an independent testable functionality, wherein the UI custom component occupies some defined area on the User Interface of the software application. For example, a date Picker can be defined as the UI custom component with functionality to get date and set date. In one embodiment, the custom component may be generated by aggregation of standard components such as command buttons, text boxes, dropdown menu, or can be made from scratch using 2D graphics API for example but not limited to Canvas or SVG API in HTML.

Further, the processor is configured to store the set of custom components and the set of metadata in an object repository. Furthermore, the processor enables a user to select a custom component from the software application for testing over a test grid. Once the custom component is selected, the processor enables identifying the metadata associated with the custom component, from the object repository. Finally, the processor enables a user to select an attribute of each category from the metadata corresponding to the custom component in order to generate an event set corresponding to the custom component. The generated event set comprises the attribute selected for testing the custom component for a particular functionality.

While aspects of the described system and method for testing a custom component associated with a software application may be implemented in any number of different computing systems, environments, and/or configurations, the embodiments are described in the context of the following exemplary system.

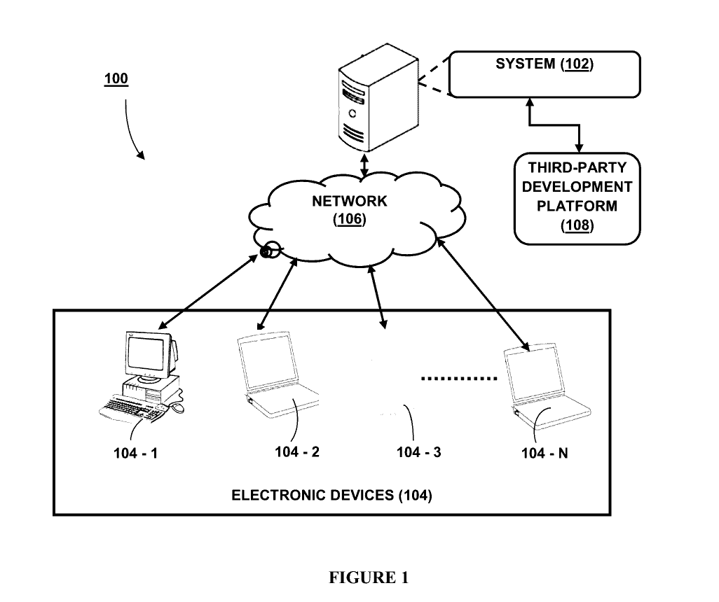

Referring now to FIG. 1, a network implementation 100 of a system 102 to test a custom component associated with the software application is disclosed, wherein the custom component is developed over a third party development platform 108. Although the present subject matter is explained considering that the system 102 is implemented on a server, it may be understood that the system 102 may also be implemented in a variety of computing systems, such as a laptop computer, a desktop computer, a notebook, a workstation, a mainframe computer, a server, a network server, and the like. In one implementation, the system 102 may be implemented in a cloud-based environment. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol

(WAP), and the like, to communicate with one another. Further the network 106 may include a variety of network devices, including routers, bridges, servers, computing devices, storage devices, and the like. Furthermore, the system 102 may be communicatively coupled with a third-party development platform 108 using the network 106. Alternatively, the system 102 may be directly connected to the third-party development platform 108 using a communication link. Furthermore, the system 102 and third-party development platform 108 may be hosted over a single server. The third-party development platform 108 is enabled with development tools for developing a set of custom components to be used in the software application. The third-party development platform 108 may enable use of advanced programming languages like HTML5 for generating the custom components. In one embodiment, each custom component from the set of custom components may be developed using a declarative language like Extensible Markup Language (XML) or HyperText Markup Language (HTML). Further, the third-party development platform 108 is also configured to develop a set of metadata corresponding to the set of custom components, wherein the set of metadata is a collection of attributes for testing the functionality of the custom components. In one embodiment, the set of metadata is defined by the third-party development platform using a declarative language. The declarative language may be selected from XML or HTML. The declarative language is any programming language that can be interpreted by the system 102. The set of metadata is in computer readable format that is parseable or readable by the system 102.

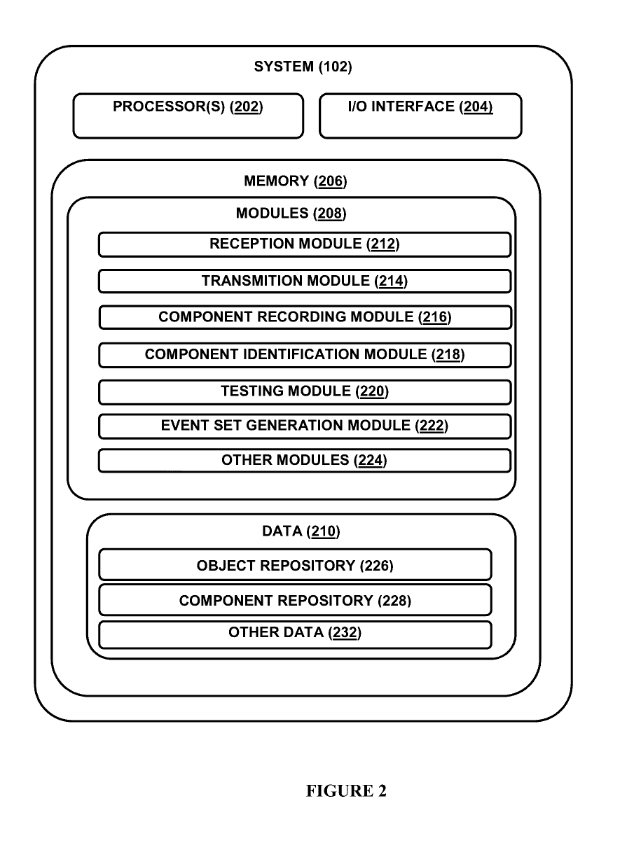

Referring now to FIG. 2, the system 102 is illustrated in accordance with an embodiment of the present subject matter. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the client devices 104. Further, the I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 206 may include modules 208 and data 210.

The modules 208 include routines, programs, objects, components, data structures, etc., which perform particular tasks, functions or implement particular abstract data types. In one implementation, the modules 208 may include a reception module 212, a transmission module 214, a component recording module 216, a component identification module 218, a testing module 220, an event set generation module 222, and other modules 224. The other modules 224 may include programs or coded instructions that supplement applications and functions of the system 102.

The data 210, amongst other things, serves as a repository for storing data processed, received, and generated by one or more of the modules 208. The data 210 may also include an object repository 226, and other data 232. The object repository 226 is configured to store the set of custom components and the set of metadata associated with each of the custom components. In one embodiment, the other data 232 may include data generated as a result of the execution of one or more modules in the other module 224.

In one implementation, at first, a user may use the client device 104 to access the system 102 via the I/O interface 204. The user may register using the I/O interface 204 in order to use the system 102. In one embodiment, once the user registers to the system 102, the user may send a software application to be tested as input to the system 102.

Once the software application is accepted by the system 102, in the next step, the reception module 212 is configured to receive a set of custom components and a set of metadata from the third-party development platform 108. The custom components may be developed using programming language such as HTML5. Further, each metadata associated with a custom component comprises a plurality of attributes categorized into a plurality of categories. The categories may include a component type, a component finder, an action, and a value associated with the custom component. In one embodiment, the set of metadata is received in form of a plurality of XML files, wherein each XML file is parsed using object XML parser in order to extract metadata from each XML file. In one embodiment, the action from the plurality of categories includes all the testable functionalities associated with the custom component. The testable functionalities are defined using a declarative language. The declarative language may be selected from XML, HTML or any other computer readable programming language. In one embodiment, the values associated with the custom component may include any values that can be used to test each of the testable functionality associated with the custom component. Further, the custom component and the extracted metadata are stored in the component repository 226 by the component recording module 216. In a similar manner, each and every custom component and its corresponding metadata is extracted and stored in the object repository 226. In one embodiment, the object repository 226 is stored in a database, wherein all the custom components and the corresponding metadata is stored in a tabulated format. The database may be selected from SQL database, NO-SQL database, or any other database that can be configured to store and retrieve information.

Further, as the part of routine development process, the custom components the component identification module 216 is configured to scan the software application and identify at least one custom component from the software application to be tested. In one embodiment, the custom component may be identified based on a custom tag associated with the custom component. Once the custom component from the software application is identified, the component identification module 218 transmits the details of the custom component to the testing module 220. The testing module 220 generates an entry of the custom component in a test grid and identifies metadata associated with the custom component from the object repository 226. Since the object repository 226 already stores all the custom components and the associated metadata, this information can be easily retrieved from the object repository 226.

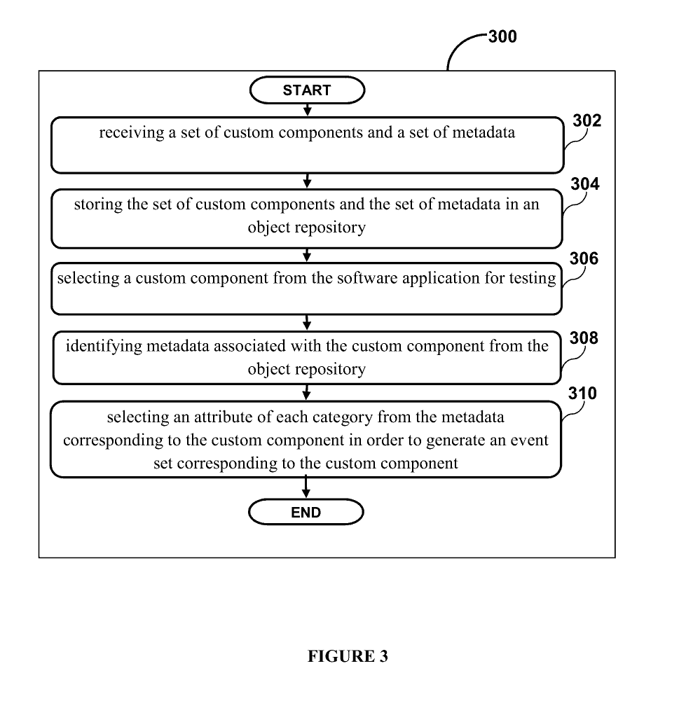

Further, the event set generation module 222 enables a dropdown menu of each category over the test grid such that a user can select an attribute of each category from the metadata corresponding to the custom component in order to generate an event set. In a similar manner, more than one event sets may be created over the test grid for testing the functionality of the custom component present in the software application. The test grid is configured to conduct keyword driven testing as well as data driven testing over the custom component. The process for testing the custom component associated with the software application is further elaborated with respect to the block diagram of FIG. 3.

FIG. 3 represents a block diagram for testing a custom component associated with the software application. At block 302, the reception module 212 is configured to receive a set of custom components and a set of metadata from the third-party development platform 108. In one embodiment, the custom components may be developed using programming language such as HTML5, JavaScript, VB.Net or any other user interface programming language used for designing user interface of the software application.

At block 304, the set of custom components and the set of metadata are stored in the component repository 226 by the component recording module 216. In one embodiment, each metadata associated with a custom component comprises a plurality of attributes categorized into a plurality of categories. The categories may include a component type, a component finder, an action, and a value associated with the custom component. In one embodiment, the set of metadata is received in form of a plurality of XML files, wherein each XML file is parsed using object XML parser in order to extract metadata from each XML file. In a similar manner, each and every custom component and its corresponding metadata is extracted and stored in the object repository 226.

At block 306, the component identification module 216 is configured to scan the software application and identify at least one custom component from the software application to be tested. In another embodiment, the user may directly select the custom component in the software application using a web browser. In one embodiment, the custom component present in the software application may be identified based on a custom tag associated with the custom component.

At block 308, once the custom component from the software application is identified, the component identification module 218 transmits the details of the custom component to the testing module 220. The testing module 220 generates an entry of the custom component in a test grid and identifies metadata associated with the custom component from the object repository 226.

At block 310, the event set generation module 222 enables a dropdown menu of each category over the test grid such that a user can select an attribute of each category from the metadata corresponding to the custom component in order to generate an event set. In a similar manner, more than one event sets may be created for testing the functionality of the custom component present in the software application.

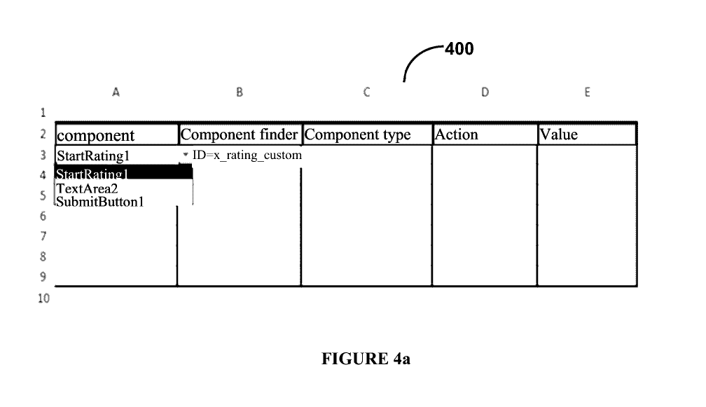

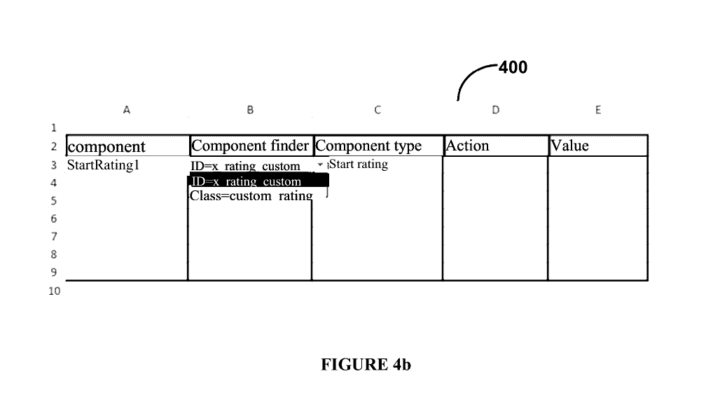

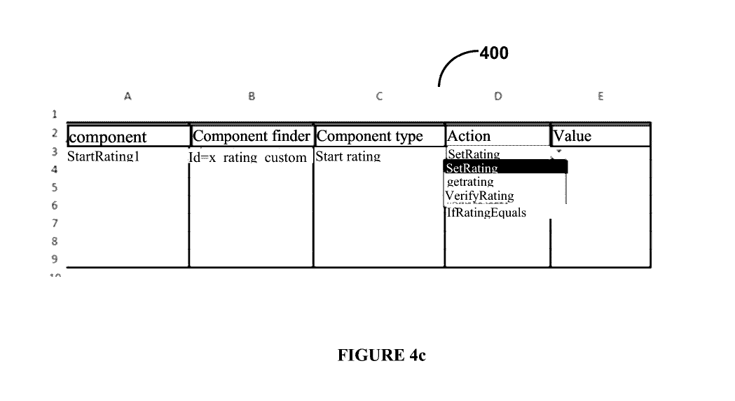

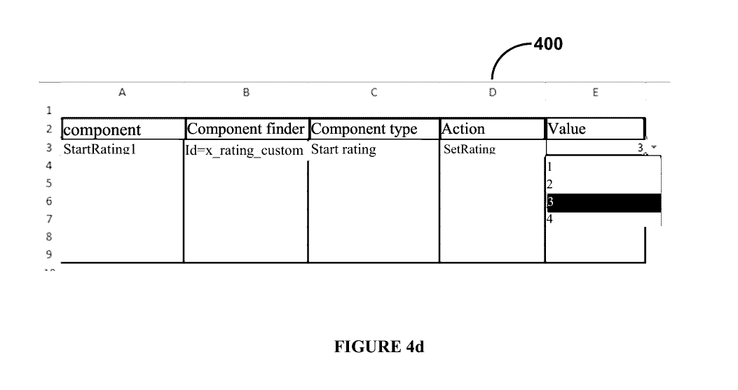

FIGS. 4a-4d illustrates a test grid 400 for testing the custom component, in accordance with an embodiment of the present subject matter. As disclosed in FIG. 4a, the test grid 400 enables a user to select at least one custom component from the set of components that are identified from the software application using a component dropdown menu. These custom components may include starRating1, testArea2, and SubmitButton1. The user may select any one of these custom component to be tested over the test grid 400.

With reference to FIG. 4b, assuming that the user selects the custom component “starRating1”, the test grid 400 enabled displaying all the component finders that are applicable to the custom component “starRating1” using a finder dropdown menu. For instance, id=x rating custom or class=custom rating may be displayed as options in the finder dropdown menu and the user may select any one of the options.

With reference to FIG. 4c, the set of actions applicable to the custom component “starRating1” are displayed in an action dropdown menu over the test grid 400. The action dropdown menu displays all the component finders that are applicable to the custom component “starRating1”. These actions may include “getRating”, “setRating”, “verifyRating”, or “ifRatingEquals”. The user may select a particular action from the action dropdown menu for the purpose of testing the custom component “starRating1.”

With reference to FIG. 4d, the set of values applicable to the custom component “starRating1” are displayed in a value dropdown menu over the test grid 400. The value dropdown menu displays all the values applicable to the custom component “starRating1”. These values may include 0, 1, 2, 3, 4, 5, and 6. The user may select a particular value from the value dropdown menu for the purpose of testing the custom component “starRating1.”

### WORKING EXAMPLE

In one example, the system enabled keyword based testing of components in the software application based on user interface of the software application. For the purpose of keyword based testing the user interface is divided into different sub components. In one embodiment, the software application may be developed at a software development platform. The software application may use a custom component “calendar”, wherein the calendar component is received from the third party development platform 108. The calendar component with its independent testable functions may be declared by the third party development platform 108 or the software application developer may also declare independent testable functions associated with the calendar component.

In one embodiment, the calendar component may include different well known components such as textboxes, command buttons, dropdown menus with independent identifiable functionality. However, it is not possible to perform keyword based testing on group of known components in the calendar component using existing automated testing tools since the functionality associated with such components is not known or declared beforehand. For example, the calendar component may include three different textboxes aligned one besides other to accept date specified by the user in DD/MM/YY format. Since the existing automated testing tools are unaware of the functionality associated with the combinations of these three textboxes, the existing automated testing tools are not able test the functionality of the three textboxes in the calendar component.

To address this problem, the system 102 enables a user to declare all possible independent functions and variable states associated with the calendar component. Further, independent functions and variable states associated with the calendar component are maintained in the form of a list of functionality and a list of variable states. The list of testable functionality forms a set of keywords for functional testing of the calendar component. In one example, the list of testable functionalities associated with the custom component such as a data picker may include “setDateAs”, “getDate”, “ is Date greater than”, “is Date Less Than”, or “does date Lie between”. In another example the testable functionalities associated with the star rating component may include “setRating”, “getRating”, or “doesRatingEquals”.

Furthermore, based on the application being developed, the calendar component is assigned with a unique identifier for the purpose of accurately detecting the calendar component in the software application. Further, the list of testable functionality, the list of variable states, and unique identifier are recorded in the form of metadata associated with the calendar component. Further, once the calendar component is added into the software application, the exact location of calendar component in the software application is recorded in a data structure. The location information is recorded in the form of length and breadth of pixels associated with the location of calendar component over the user interface at a given time in the software application.

In a similar manner, the location of each and every component in the software application is recorded by the custom component Identification tool. Further, the process of keyword based testing of the calendar component starts by detecting the presence of the calendar component over the user interface of the software application. For the purpose of testing the calendar component, a tester may right click the calendar component over the user interface. The system 102 automatically determines the location of mouse pointer at a given graphical Point and determines the calendar component that is right clicked using Functional Component declaration and Object Inspection.

In one embodiment, if the software application is anon-browser based applications like native applications or a mobile/tablet based software applications, then the non-browser based application may also provide the location of all functional components present in non-browser based application. Further, the components can be hovered or right clicked on the snapshot to get the metadata such as component type, the list of testable functionality, the list of variable states, and unique identifier associated with the calendar component is retrieved from the object repository 226.

Further, the system 102 generates an entry of the calendar component in a test grid and identifies metadata associated with the calendar component from the object repository 226. Further, the system 102 enables a dropdown menu of each category over the test grid such that a user can select an attribute of each category from the metadata corresponding to the calendar component in order to generate an event set. In a similar manner, more than one event sets may be created for testing the functionality of the calendar component present in the software application.

Although implementations for methods and systems for testing a custom component associated with a software application have been described, it is to be understood that the appended claims are not necessarily limited to the specific features or methods described. Rather, the specific features and methods are disclosed as examples of implementations for testing the custom component associated with the software application.

We claim:

1. A method for testing a custom component associated with a software application, the method comprising:
receiving, by a processor, a set of custom components and a set of metadata associated with the set of custom components, wherein each metadata comprises a plurality of attributes categorized into a plurality of categories;
storing, by the processor, the set of custom components and the set of metadata in an object repository;
selecting a custom component, from the software application, for testing over a test grid;
identifying, by the processor, metadata associated with the custom component from the object repository; and
selecting an attribute of each category from the metadata corresponding to the custom component in order to generate an event set corresponding to the custom component, wherein the event set comprises the attribute selected for testing the custom component.

2. The method of claim 1, wherein the each component from the set of components is defined using a declarative language, wherein the declarative language is selected from but not limited to Extensible Markup Language (XML) or Hyper Text Markup Language (HTML).

3. The method of claim 1, wherein the test grid is configured to conduct keyword based testing and data driven testing of the custom components.

4. The method of claim 1, wherein the plurality of categories comprises a component type, a component finder, an action, and a value.

5. The method of claim 4, wherein the action from the plurality of categories include all the testable functionalities associated with the custom component, wherein the testable functionalities are defined using the declarative language.

6. The method of claim 1, wherein the set of metadata is received in a form of a plurality of XML files, wherein each XML file is parsed using an object XML parser in order to extract metadata from each XML file, and wherein the metadata is further stored in the object repository after the extraction.

7. The method of claim 1, wherein the object repository is stored in a database.

8. A system for testing a custom component associated with a software application, the system comprising:
a memory; and
a processor coupled to the memory, wherein the processor is configured to perform the steps of:
receiving a set of custom components and a set of metadata associated with the set of components, wherein each metadata comprises a plurality of attributes categorized into a plurality of categories;
storing the set of custom components and the set, of metadata in an object repository;
selecting a custom component, from the software application, for testing over a test grid;
identifying metadata associated with the custom component from the object repository; and
selecting an attribute of each category from the metadata corresponding to the custom component in order to generate an event set corresponding to the custom component, wherein the event set comprises the attribute selected for testing the custom component.

9. The system of claim 8, wherein the each component from the set of components is defined using a declarative language, wherein the declarative language is selected from but not limited to Extensible Markup Language (XML) or Hyper Text Markup Language (HTML).

10. The system of claim 8, wherein the test grid is configured to conduct keyword based testing and data driven testing of the custom components.

11. The system of claim 8, wherein the plurality of categories comprises a component type, a component finder, an action, and a value.

12. The system of claim 11, wherein the action from the plurality of categories includes all the testable functionalities associated with the custom component, wherein the testable functionalities are defined using the declarative language.

13. The system of claim 8, wherein the set of metadata is received in a form of a plurality of XML files, wherein each XML file is parsed using an object XML parser in order to extract metadata from each XML file, and wherein the metadata is further stored in the object repository after the extraction.

14. The system of claim 8, wherein the object repository is stored in a SQL database.

15. A computer program product having embodied thereon a computer program for testing a custom component associated with a software application, the computer program product comprising:
a program code for receiving a set of custom components and a set of metadata associated with the set of components, wherein each metadata comprises a plurality of attributes categorized into a plurality of categories;
a program code for storing the set of custom components and the set of metadata in an object repository;
a program code for selecting a custom component, from the software application, for testing over a test grid;
a program code for identifying metadata associated with the custom component from the object repository; and
a program code for selecting an attribute of each category from the metadata corresponding to the custom component in order to generate an event set corresponding to the custom component, wherein the event set comprises the attribute selected for testing the custom component.
